(19) United States
(12) Patent Application Publication
(10) Pub. No.: US 2024/0036711 A1
(43) Pub. Date: Feb. 1, 2024

(54) Controlling an Interface Using Gaze Input

(71) Applicant: Apple Inc., Cupertino, CA (US)

(72) Inventor: Gregory Lutter, Boulder Creek, CA (US)

(21) Appl. No.: 18/339,091

(22) Filed: Jun. 21, 2023

Related U.S. Application Data
(60) Provisional application No. 63/394,225, filed on Aug. 1, 2022.

(51) Int. Cl. G06F 3/0484; G06F 3/01

(52) U.S. Cl. CPC G06F 3/0484; G06F 3/013; G06F 3/012; G06F 2203/04806

(57) ABSTRACT

In a head-mounted device, gaze input may be used to select a user interface element that is displayed on a display. To select a user interface element, the user may target the user interface element with gaze input. Targeting the user interface element with gaze input may cause the user interface element to shift towards a selection region (which may be identified using a displayed selection indicator). The user interface element may continue to shift towards the selection region while being targeted by gaze input. If the user interface element is targeted with gaze input while in the selection region, the user interface element is considered to have been selected and an action associated with the user interface element may be performed. Multiple user interface elements in a list may shift in unison when one of the user interface elements shifts due to gaze input.

This application claims priority to U.S. provisional patent application No. 63/394,225, filed Aug. 1, 2022, which is hereby incorporated by reference herein in its entirety.

### BACKGROUND

This relates generally to head-mounted devices, and, more particularly, to head-mounted devices with displays.

Some electronic devices such as head-mounted devices include displays that are positioned close to a user's eyes during operation (sometimes referred to as near-eye displays). The positioning of the near-eye displays may make it difficult to provide touch input to these displays. Accordingly, it may be more difficult than provide user input to the head-mounted device.

### SUMMARY

An electronic device may include one or more sensors, one or more displays, one or more processors, and memory storing instructions configured to be executed by the one or more processors, the instructions for: displaying, using the one or more displays, a user interface element, obtaining, via the one or more sensors, a gaze input, in accordance with a determination that the gaze input targets the user interface element and the user interface element is not located at a selection region, shifting the user interface element towards the selection region, and in accordance with a determination that the gaze input targets the user interface element and the user interface element is located at the selection region, performing an action associated with the user interface element.

### BRIEF DESCRIPTION OF THE DRAWINGS

FIG. 1 is a schematic diagram of an illustrative head-mounted device in accordance with some embodiments.

FIGS. 2A-2C are diagrams of an illustrative user of a head-mounted device showing how the user's head pose may be defined by yaw, roll, and pitch, respectively in accordance with some embodiments.

FIGS. 3A-3E are views of an illustrative display with a user interface element that is selected based on gaze input in accordance with some embodiments.

FIG. 4A is a view of an illustrative selection indicator that is a partial outline of a selection region in accordance with some embodiments.

FIG. 4B is a view of an illustrative selection indicator that is a complete outline of a selection region in accordance with some embodiments.

FIG. 4C is a view of an illustrative selection indicator that is a highlight of a selection region in accordance with some embodiments.

FIG. 5A is a view of an illustrative display with user interface elements in a wrap-around list in accordance with some embodiments.

FIG. 5B is a view of an illustrative display with user interface elements in a list that is populated with new items when shifted in accordance with some embodiments.

FIG. 6A is a view of an illustrative display with a user interface element in a selection region in accordance with some embodiments.

FIG. 6B is a view of an illustrative display showing a user interface element that is enlarged when selected in accordance with some embodiments.

FIG. 6C is a view of an illustrative display showing a new user interface element that is displayed in response to selection of a user interface element in accordance with some embodiments.

FIGS. 7A-7C are views of an illustrative display with a user interface element that is selected based on gaze input and head pose information in accordance with some embodiments.

FIG. 8 is a flowchart showing an illustrative method performed by a head-mounted device in accordance with some embodiments.

### DETAILED DESCRIPTION

In some head-mounted devices, gaze input may be used to provide user input to the head-mounted device. In particular, targeting a user interface element with gaze input may cause the user interface element to gradually shift towards a selection region. When the gaze input targets the user interface element while the user interface element is in the selection region, the user interface element may be considered to have been selected by the user and an action associated with the user interface element may be performed. This provides a method for the user to select a user interface element without touching the display.

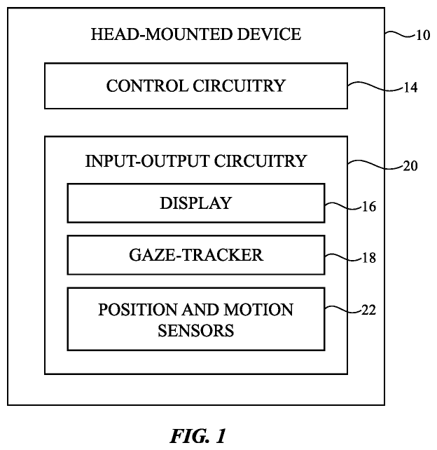

A schematic diagram of an illustrative head-mounted device is shown in FIG. 1. As shown in FIG. 1, head-mounted device 10 (sometimes referred to as electronic device 10, system 10, head-mounted display 10, etc.) may have control circuitry 14. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 20. Input-output circuitry 20 may be used to allow data to be received by head-mounted device 10 from external equipment (e.g., a tethered computer, a portable device such as a handheld device or laptop computer, or other electrical equipment) and to allow a user to provide head-mounted device 10 with user input. Input-output circuitry 20 may also be used to gather information on the environment in which head-mounted device 10 is operating. Output components in circuitry 20 may allow head- mounted device 10 to provide a user with output and may be used to communicate with external electrical equipment.

As shown in FIG. 1, input-output circuitry 20 may include a display such as display 16. Display 16 may be used to display images for a user of head-mounted device 10. Display 16 may be a transparent display so that a user may observe physical objects through the display while computer-generated content is overlaid on top of the physical objects by presenting computer-generated images on the display. A transparent display may be formed from a transparent pixel array (e.g., a transparent organic light-emitting diode display panel) or may be formed by a display device that provides images to a user through a beam splitter, holographic coupler, or other optical coupler (e.g., a display device such as a liquid crystal on silicon display). Alternatively, display 16 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 16 is opaque, the display may also optionally display entirely computer-generated content (e.g., without displaying images of the physical environment).

Display 16 may include one or more optical systems (e.g., lenses) that allow a viewer to view images on display(s) 16. A single display 16 may produce images for both eyes or a pair of displays 16 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 20 may include various other input-output devices for gathering data and user input and for supplying a user with output. For example, input-output circuitry 20 may include a gaze-tracker 18 (sometimes referred to as a gaze-tracking system or a gaze-tracking camera). The gaze-tracker 18 may be used to obtain gaze input from the user during operation of head-mounted device 10.

Gaze-tracker 18 may include a camera and/or other gaze-tracking system components (e.g., light sources that emit beams of light so that reflections of the beams from a user's eyes may be detected) to monitor the user's eyes. Gaze-tracker(s) 18 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 18 is merely illustrative.

As shown in FIG. 1, input-output circuitry 20 may include position and motion sensors 22 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 22, for example, control circuitry 14 can monitor the current direction in which a user's head is oriented relative to the surrounding environment (e.g., a user's head pose). In one example, position and motion sensors 22 may include one or more outward-facing cameras (e.g., that capture images of a physical environment surrounding the user). The outward-facing cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique). In addition to being used for position and motion sensing, the outward-facing camera may capture pass-through video for device 10.

Input-output circuitry 20 may also include other sensors and input-output components if desired (e.g., ambient light sensors, force sensors, temperature sensors, touch sensors, buttons, capacitive proximity sensors, light-based proximity sensors, other proximity sensors, strain gauges, gas sensors, pressure sensors, moisture sensors, magnetic sensors, microphones, speakers, audio components, haptic output devices, light-emitting diodes, other light sources, wired and/or wireless communications circuitry, etc.).

A user may sometimes provide user input to head-mounted device 10 using position and motion sensors 22. In particular, position and motion sensors 22 may detect changes in head pose (sometimes referred to as head movements) during operation of head-mounted device 10.

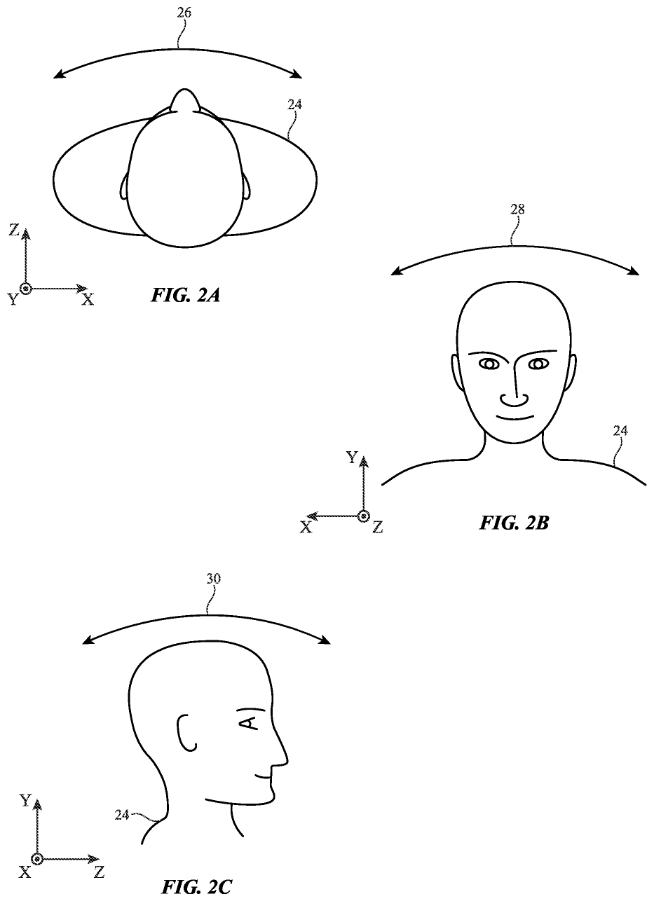

Changes in yaw, roll, and/or pitch of the user's head (and, correspondingly, the head-mounted device) may all be interpreted as user input if desired. FIGS. 2A-2C show how yaw, roll, and pitch may be defined for the user's head. FIGS. 2A-2C show a user 24. In each one of FIGS. 2A-2C, the user is facing the Z-direction and the Y-axis is aligned with the height of the user. The X-axis may be considered the side-to-side axis for the user's head, the Z-axis may be considered the front-to-back axis for the user's head, and the Y-axis may be considered the vertical axis for the user's head. The X-axis may be referred to as extending from the user's left ear to the user's right ear, as extending from the left side of the user's head to the right side of the user's head, etc. The Z-axis may be referred to as extending from the back of the user's head to the front of the user's head (e.g., to the user's face). The Y-axis may be referred to as extending from the bottom of the user's head to the top of the user's head.

As shown in FIG. 2A, yaw may be defined as the rotation around the vertical axis (e.g., the Y-axis in FIGS. 2A-2C). As the user's head rotates along direction 26, the yaw of the user's head changes. Yaw may sometimes alternatively be referred to as heading. The user's head may change yaw by rotating to the right or left around the vertical axis. A rotation to the right around the vertical axis (e.g., an increase in yaw) may be referred to as a rightward head movement. A rotation to the left around the vertical axis (e.g., a decrease in yaw) may be referred to as a leftward head movement.

As shown in FIG. 2B, roll may be defined as the rotation around the front-to-back axis (e.g., the Z-axis in FIGS. 2A-2C). As the user's head rotates along direction 28, the roll of the user's head changes. The user's head may change roll by rotating to the right or left around the front-to-back axis. A rotation to the right around the front-to-back axis (e.g., an increase in roll) may be referred to as a rightward head movement. A rotation to the left around the front-to-back axis (e.g., a decrease in roll) may be referred to as a leftward head movement.

As shown in FIG. 2C, pitch may be defined as the rotation around the side-to-side axis (e.g., the X-axis in FIGS. 2A-2C). As the user's head rotates along direction 30, the pitch of the user's head changes. The user's head may change pitch by rotating up or down around the side-to-side axis. A rotation down around the side-to-side axis (e.g., a decrease in pitch following the right arrow in direction 30 in FIG. 2C) may be referred to as a downward head movement. A rotation up around the side-to-side axis (e.g., an increase in pitch following the left arrow in direction 30 in FIG. 2C) may be referred to as an upward head movement.

It should be understood that position and motion sensors 22 may directly determine pose, movement, yaw, pitch, roll, etc. for head-mounted device 10. Position and motion sensors 22 may assume that the head-mounted device is mounted on the user's head. Therefore, herein, references to head pose, head movement, yaw of the user's head, pitch of the user's head, roll of the user's head, etc. may be considered interchangeable with references to references to device pose, device movement, yaw of the device, pitch of the device, roll of the device, etc.

At any given time, position and motion sensors 22 (and/or control circuitry 14) may determine the yaw, roll, and pitch of the user's head. The yaw, roll, and pitch of the user's head may collectively define the orientation of the user's head pose. Detected changes in head pose (e.g., orientation) may be used as user input to head-mounted device 10.

Gaze input (e.g., from gaze-tracker 18 in FIG. 1) may be used as user input to head-mounted device 10. In particular, gaze input may be used to select a user interface element that is displayed on display 16 of head-mounted device 10. To select a user interface element, the user may target the user interface element with gaze input. Targeting the user interface element with gaze input may cause the user interface element to shift towards a selection region (which may sometimes be identified using a displayed selection indicator). The user interface element may continue to shift towards the selection region while being targeted by gaze input. If the user interface element is targeted with gaze input while located at the selection region, the user interface element is considered to have been selected and an action associated with the user interface element may be performed. Multiple user interface elements may be displayed on head-mounted device 10 (e.g., in a list). The user interface elements in the list may shift in unison when one of the user interface elements shifts due to gaze input.

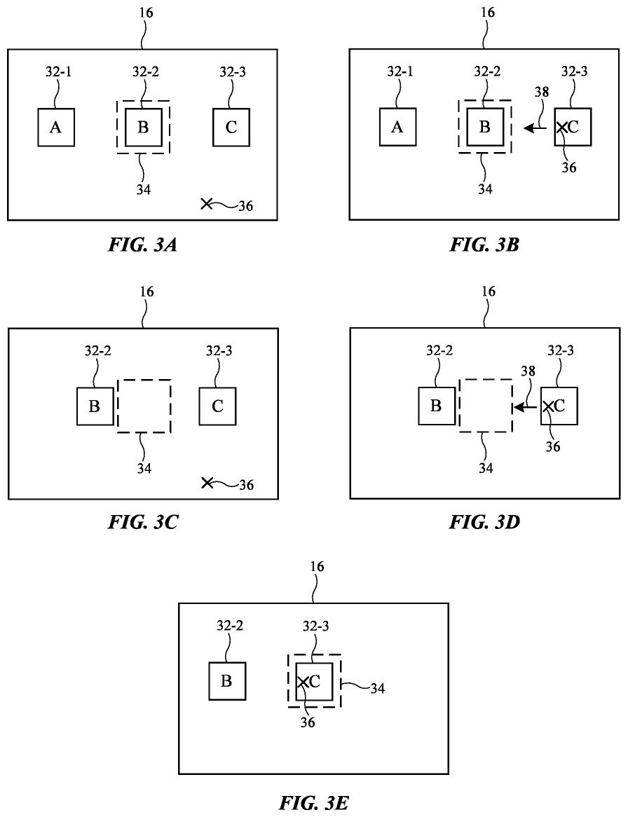

FIGS. 3A-3E are views of display 16 with a selection region for user selection using gaze input. As shown in FIGS. 3A-3E, multiple user interface elements may be displayed on display 16. In the example of FIG. 3A, a first user interface element 32-1, a second user interface element 32-2, and a third user interface element 32-3 are displayed on display 16. Each user interface element may have respective content (e.g., the letter “A” is displayed in user interface element 32-1, the letter “B” is displayed in user interface element 32-2, and the letter “C” is displayed in user interface element 32-3).

Display 16 includes a selection region 34 that is associated with selection of a user interface element. The head-mounted device 10 (e.g., control circuitry 14) may interpret a selection when the user's gaze input targets a user interface element that is positioned within selection region 34.

In FIGS. 3A-3E, the selection region is in a central portion of the display (e.g., in a center of the user's field-of-view), but this example is merely illustrative. The selection region may be located in any desired portion of the display. The selection region may remain in a fixed position on the display (e.g., as a head-locked region even as user interface elements shift across the display and/or are selected) or may remain in a fixed position in an environment (e.g., as a world-locked or body-locked region even as the user turns their head).

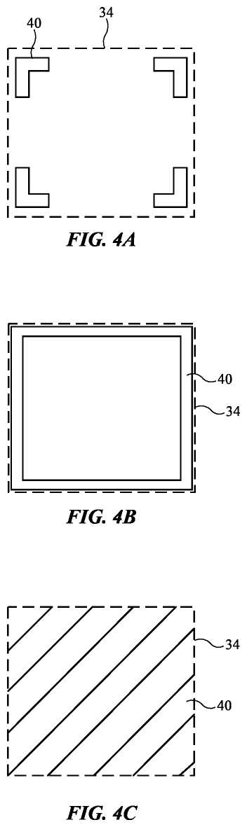

As will be shown and discussed in connection with FIGS. 4A-4C, a selection indicator may be displayed at selection region 34 to visually identify the position of the selection region to a viewer. However, this need not be the case. As shown in FIGS. 3A-3E, there may be no displayed selection indicator on the display if desired. In this case, the location of the selection region may be known to the viewer from a tutorial and/or from the selection region being placed in an intuitive (e.g., central) location on the display.

In FIG. 3A, point of gaze 36 for the user does not target any of the displayed user interface elements. When point of gaze 36 does not target any user interface elements, the positions of the user interface elements on the display remain fixed and no selection of any user interface element is made.

In FIG. 3B, point of gaze 36 targets user interface element 32-3. Targeting a user interface element with gaze input causes that user interface element to shift towards selection region 34 (assuming that user interface element is not already located at the selection region). As shown in FIG. 3B, user interface element 32-3 is targeted by point of gaze 36 and therefore shifts in direction 38 towards selection region 34. The shift of the user interface element may be at a uniform speed or a non-uniform speed (e.g., faster when far from the selection region and slower when close to the selection region). The shift of the user interface element may be based on applying a uniform or non-uniform acceleration to the user interface element.

User interface element 32-3 may continue to shift towards selection region 34 as long as point of gaze 36 targets (overlaps) user interface element 32-3 (and the user interface element is not already located at the selection region). In FIG. 3C, point of gaze 36 no longer targets user interface element 32-3 (or any of the other user interface elements on the display). Accordingly, user interface element 32-3 remains in a fixed position (instead of moving in direction 38 as in FIG. 3B). In alterative examples, the closest user interface element to the selection region may be quickly shifted (e.g., snapped) to the selection region in response to the point of gaze no longer targeting any of the user interface elements.

In FIG. 3D, point of gaze 36 again targets user interface element 32-3. Accordingly, user interface element 32-3 again shifts in direction 38 towards selection region 34 (similar to as in FIG. 3B).

Once the user interface element 32-3 is centered within selection region 34, the user interface element 32-3 may cease shifting towards the selection region and remain in a fixed position within the selection region. FIG. 3E shows an example where user interface element 32-3 is centered within the selection region 34.

The user interface element 32-3 may be considered eligible for selection once the user interface element is located at the selection region. The criteria to be considered located at selection region may vary (e.g., the user interface element must be centered within the selection region, the user interface element must be entirely contained within the selection region, the user interface element must be at least partially overlapping the selection region, etc.). Once the user interface element is eligible for selection (due to being located at the selection region as determined by control circuitry 14), the user interface element is considered to be selected by control circuitry 14 when gaze input targets the user interface element.

In FIG. 3E, the user interface element 32-3 is within selection region 34 and targeted by point of gaze 36. Accordingly, the user interface element 32-3 may be considered to be selected in FIG. 3E.

If desired, the user interface element within selection region 34 may only be considered to be selected when the gaze input targets the user interface element while the user interface element is within the selection region for at least a given dwell time (e.g., more than 50 milliseconds, more than 100 milliseconds, more than 200 milliseconds, more than 500 milliseconds, more than 1 second, etc.).

There are numerous possible selection indicators that may be displayed on display 16 to visually identify the position of selection region 34 for the viewer. FIG. 4A shows a selection region 34 with a selection indicator 40 that forms a partial outline around the selection region. In FIG. 4A, the selection indicator has four discrete portions, each positioned at a corner of the selection region. This example is merely illustrative. In another possible arrangement, shown in FIG. 4B, the selection indicator 40 may form a complete outline around the selection region 34. In other words, the selection indicator 40 forms a closed loop at the periphery of selection region 34. In yet another possible arrangement, shown in FIG. 4C, the selection indicator 40 may be a highlighted portion of the display. The highlight may be a yellow highlight or highlight of another color with sufficient transparency to allow the underlying content to still be visible.

In the example of FIGS. 3A-3E, user interface elements 32-1, 32-2, and 32-3 are displayed in a list. This example is merely illustrative. In general, the concept of shifting a user interface element towards a selection region may be applied to any user interface element, regardless of whether the user interface element is part of a larger list or not.

When the user interface element is part of a list (as depicted in FIGS. 3A-3E), the user interface elements of the list may move in unison. For example, when user interface element 32-3 is shifted in direction 38 in FIG. 3B, the other user interface elements are also shifted in direction 38 at the same rate. Displacement of user interface element 32-3 by a first amount therefore displaces the other user interface elements in the list by the first amount.

There are various ways for the list to respond when elements in the list are shifted off of the display. In one possible arrangement, shown in FIGS. 3C-3E, items in the list may be shifted off of the display without any additional replacement items to populate the off-display items.

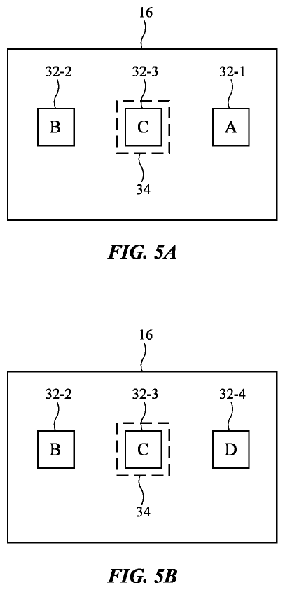

In another possible arrangement, shown in FIG. 5A, the list may wrap around when shifted off the display. In other words, instead of shifting user interface element 32-1 off the display (as in FIGS. 3C-3E), user interface element 32-1 in FIG. 5A may wrap around and be displayed on the other side of the display (e.g., user interface element 32-1 is shifted off the screen to the left and simultaneously emerges from the right side of the display). Using a convention where the left side of the display is considered the beginning of the list of user interface elements and the right side of the display is considered the end of the list of user interface elements, a user interface element may be shifted from the beginning of the list to the end of the list when being shifted off the display to the left. Alternatively, a user interface element may be shifted from the end of the list to the beginning of the list when being shifted off the display to the right.

In yet another possible arrangement, shown in FIG. 5B, the list may populate new elements when items in the list are shifted off the display. In FIG. 5B, a new user interface element 32-4 is shifted onto the display in response to user interface element 32-1 being shifted off the display.

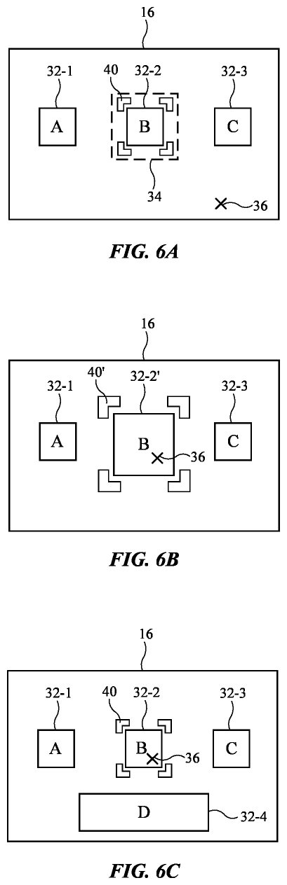

There are numerous possible actions that may be taken by control circuitry 14 in response to a user interface element being selected (e.g., by gaze input targeting the user interface element while the user interface element is located at selection region). FIG. 6A is a view of a display with a user interface element 32-2 located at selection region 34 (as identified by selection indicator 40). In FIG. 6A, point of gaze 36 does not target the user interface element 32-2 so the user interface element 32-2 is not selected.

In FIG. 6B, point of gaze 36 targets user interface element 32-2 while the user interface element is in selection region 34 so the user interface element 32-2 is selected. In FIG. 6B, selecting the user interface element 32-2 causes the user interface element 32-2 to be enlarged into an enlarged version 32-2′. The content within the enlarged user interface element 32-2′ may be the same as before selection, just increased in size. The selection may also cause the selection indicator 40 to be enlarged into an enlarged version 40′. The appearance of the enlarged selection indicator 40′ may be the same as before selection, just increased in size.

FIG. 6C shows an alternate action that may be performed in response to selection of the user interface element. In FIG. 6C, point of gaze 36 targets user interface element 32-2 while the user interface element is in selection region 34 so the user interface element 32-2 is selected. In FIG. 6C, selecting the user interface element 32-2 causes a new user interface element 32-4 with new content (e.g., the letter “D”) to be displayed. The new user interface element 32-4 may be displayed adjacent to selection region 34 (e.g., below the selection region 34 as in FIG. 6C).

The actions depicted in FIGS. 6B and 6C in response to selection of the user interface element are merely illustrative. Other possible actions in response to selection of the user interface element include the content of the selected user interface element being replaced (overlayed) with new content, clicking the user interface element (e.g., on a web page), updating a setting of one or more components within head-mounted device 10, etc. For example, a setting for any components of input-output circuitry 20 in FIG. 1 may be updated in response to the selection (e.g., the volume of a speaker, the brightness of a display, a camera setting, etc.).

In one possible arrangement, a user interface element may shift towards the selection region at a constant rate when targeted by gaze input. In another possible arrangement, a user interface element may shift towards the selection region at a variable rate when targeted by gaze input. Head pose information (head movements) may optionally be used to adjust the variable rate.

In FIGS. 6A-6C, actions are taken in response to gaze input targeting the user interface element while the user interface element is located at selection region. In another possible arrangement, an action associated with the user interface element may be started when the gaze input targets the user interface element (and before the user interface element is located in the selection region). For example, in FIG. 3B when the gaze input targets user interface element 32-3 and the user interface element 32-3 is not positioned within the selection region, a first action associated with user interface element 32-3 may be performed (e.g., user interface element 32-3 may be enlarged or a new user interface element associated with user interface element 32-3 may be displayed). Simultaneously, the targeted user interface element may shift towards the selection region. When the user interface element is positioned within the selection region while still targeted with the gaze input, a second action may be performed (e.g., a setting of a component within head-mounted device 10 may be updated).

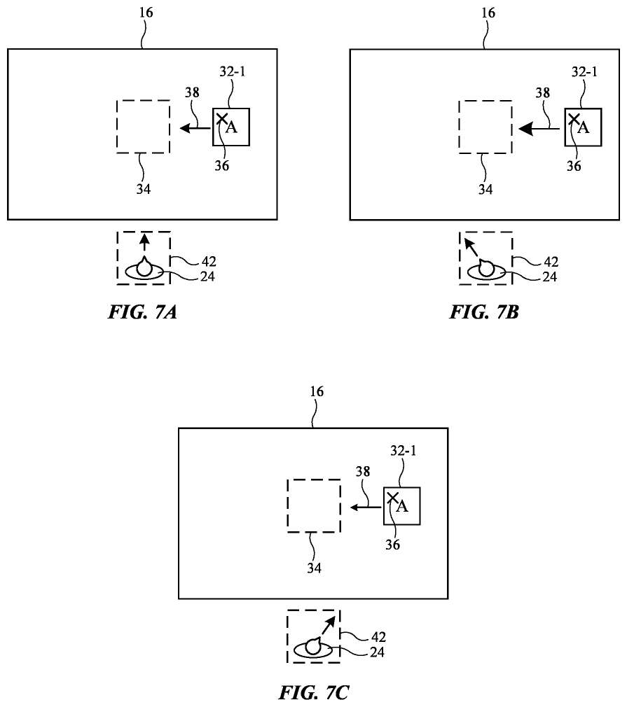

FIGS. 7A-7C are views of display 16 with a selection region 34. Each one of FIGS. 7A-7C also shows the user's head pose in area 42. In each one of FIGS. 7A-7C, point of gaze 36 targets user interface element 32-1 and, accordingly, user interface element 32-1 shifts towards selection region 34 in direction 38.

The rate at which user interface element 32-1 shifts in direction 38, however, may be dependent on the head pose of user 24. In FIG. 7A, the user's head is facing directly forward (e.g., with a yaw of 0 degrees). In this head pose, the user interface element may shift at a first rate (sometimes referred to as a default rate or a baseline rate).

In FIG. 7B, yaw of the user's head changes in the negative direction (e.g., the user turns their head to the left). The negative direction may be determined relative to a baseline direction. The baseline direction may be defined relative to the starting head pose when the gaze input initially targets the user interface element, may be defined relative to a portion of the user's body such as the user's torso (e.g., the baseline direction is a forward vector associated with the user's head facing directly forward as in FIG. 7A), or may be defined relative to the physical environment. In other words, the user has made a leftward head movement between FIGS. 7A and 7B. The user interface element 32-1 is also shifting to the left towards selection region 34. The head movement in the same direction that the user interface element is shifting may cause the user interface element to shift at a second rate that is greater than the first rate. In some embodiments, the head movement in the same direction that the user interface element is shifting may cause the user interface element to shift at a second rate that is equal to the first rate. In some embodiments, the head movement in the same direction that the user interface element is shifting may cause the user interface element to shift at a second rate that is less than the first rate.

In FIG. 7C, yaw of the user's head changes in the positive direction (e.g., the user turns their head to the right). The positive direction may be determined relative to the baseline direction discussed above. In other words, the user has made a rightward head movement between FIGS. 7B and 7C. The user interface element 32-1 is shifting to the left towards selection region 34. The head movement in the opposite direction than the user interface element is shifting may cause the user interface element to shift at a third rate that is less than the first rate. In some embodiments, the head movement in the opposite direction than the user interface element is shifting may cause the user interface element to shift at a third rate that is equal to the first rate. In some embodiments, the head movement in the opposite direction than the user interface element is shifting may cause the user interface element to shift at a third rate that is greater than the first rate. Causing the user interface element to shift at a third rate that is greater than the first rate in response to the head movement in the opposite direction than the user interface element is shifting may cause the user interface element to shift at a greater rate when the user rotates their head to look at the user interface element (which may be desirable in some embodiments).

The specific scheme for using head pose to adjust the rate of movement of user interface element 32-1 in FIGS. 7A-7C is merely illustrative. The rate of movement of user interface element 32-1 may be adjusted based on the yaw, pitch, and/or roll of the user's head. In general, head pose information may be used in any desired manner to control the movement and selection of user interface elements on display 16.

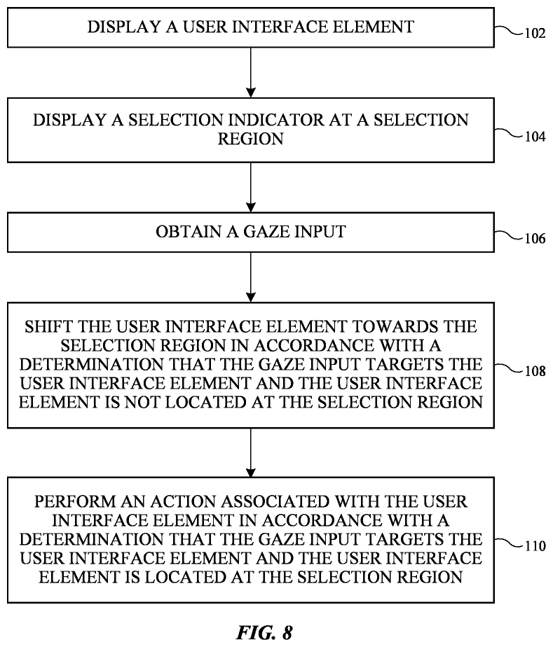

FIG. 8 is a flowchart showing an illustrative method performed by a head-mounted device (e.g., control circuitry 14 in device 10). The blocks of FIG. 8 may be stored as instructions in memory of head-mounted device 10, with the instructions configured to be executed by one or more processors in the head-mounted device.

At block 102, display 16 may display a user interface element. The user interface element may be the only user interface element on the display or may be one of multiple user interface elements on the display. The user interface element may optionally be part of a list of user interface elements. Each user interface element may include any desired type of content (e.g., text, a photo, an icon, etc.).

In the example of FIGS. 3A-3E, user interface elements 32-1, 32-2, and 32-3 are displayed in a list at block 102.

At block 104, a selection indicator may be displayed at a selection region on display 16. The selection indicator may have the appearance of a partial outline of the selection region (as in FIG. 4A), a complete outline of the selection region (as in FIG. 4B), a highlighted area (as in FIG. 4C), or any other desired appearance. In some arrangements, no selection indicator is used to visually identify the selection region and block 104 is omitted.

In the example of FIGS. 3A-3E, no selection indicator is displayed at selection region 34 and bock 104 is omitted. However, a selection indicator may optionally be displayed at selection region 34 in FIGS. 3A-3E at block 104 if desired.

At block 106, gaze-tracker 18 may obtain gaze input from the user of head-mounted device 10. The gaze-tracker may determine the location of a point of gaze of the user on display 16.

In the example of FIGS. 3A-3E, gaze-tracker 18 repeatedly determines the location of point of gaze 36 on the display at block 106.

At block 108, control circuitry 14 may shift the user interface element towards a selection region in accordance with a determination that the gaze input targets the user interface element and the user interface element is not located at the selection region. The user interface element may shift towards the selection region continuously and/or gradually. The user interface element may shift towards the selection region at a constant rate or at a variable rate. The variable rate may vary between only a preset number of rates (e.g., first, second, and third rates) or between any rate within a target range.

One example for a variable rate is for the user interface element to move at an increasing rate as the duration of time the user interface element is targeted by gaze input increases (e.g., the user interface element shifts slowly when first targeted by gaze input and shifts increasingly faster while the user interface element continues to be targeted by gaze input).

Another example of a variable rate is for the user interface element to move at a variable rate that is dependent on the user's head pose (as shown and described in connection with FIGS. 7A-7C). For example, if the user interface element is shifting in a first direction, a head movement in the first direction may increase the variable rate and a head movement in a second direction that is opposite the first direction may decrease the variable rate. Head pose changes in any direction relative to a forward vector while the user interface element is targeted may be used to adjust the variable rate. For example, if the head is turned towards a user interface element while the user interface element is targeted with gaze input, the variable rate may be increased.

If the user interface element shifted at block 108 is part of a list of user interface elements, the remaining user interface elements in the list may be shifted in unison with the targeted user interface element. As items in the list are shifted off the display, the items in the list may remain fixed (as in FIG. 3E), may wrap around items (as in FIG. 5A), or may populate new items (as in FIG. 5B).

In the example of FIGS. 3A-3E, user interface element 32-3 shifts towards selection region 34 (e.g., in FIGS. 3B and 3D) in response to a determination in block 108 that the gaze input targets user interface element 32-3 and user interface element 32-3 is not located at the selection region 34.

At block 108, in accordance with a determination that the gaze input targets the user interface element and the user interface element is not located at the selection region, an action associated with the user interface element may be performed. The action may be a first action that is followed up (e.g., in subsequent block 110) with a second action when the gaze input targets the user interface element and the user interface element is located at the selection region.

At block 110, control circuitry 14 may perform an action associated with the user interface element in accordance with a determination that the gaze input targets the user interface element and the user interface element is located at the selection region.

Any desired criteria may be used to determine when the user interface element is located at the selection region. For example, control circuitry 14 may perform an action associated with the user interface element in accordance with a determination that the gaze input targets the user interface element and the user interface element is centered within the selection region, control circuitry 14 may perform an action associated with the user interface element in accordance with a determination that the gaze input targets the user interface element and the user interface element is entirely located within the selection region, or control circuitry 14 may perform an action associated with the user interface element in accordance with a determination that the gaze input targets the user interface element and the user interface element is at least partially within the selection region.

Any desired action may be performed at block 110. The selected user interface element may be enlarged (as in FIG. 6B), a new user interface element associated with the selected user interface element may be displayed (as in FIG. 6C), the content of the selected user interface element may change, a setting of a component within head-mounted device 10 may be updated, etc.

In the example of FIGS. 3A-3E, user interface element 32-3 is selected in FIG. 3E and control circuitry 14 performs an action associated with user interface element 32-3 in accordance with a determination that the gaze input targets user interface element 32-3 and user interface element 32-3 is located at selection region 34.

Out of an abundance of caution, it is noted that to the extent that any implementation of this technology involves the use of personally identifiable information, implementers should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device comprising:
one or more sensors;
one or more displays;
one or more processors; and
memory storing instructions configured to be executed by the one or more processors, the instructions for:
displaying, using the one or more displays, a user interface element;
obtaining, via a first subset of the one or more sensors, a gaze input;
in accordance with a determination that the gaze input targets the user interface element and the user interface element is not located at a selection region, shifting the user interface element towards the selection region; and
in accordance with a determination that the gaze input targets the user interface element and the user interface element is located at the selection region, performing an action associated with the user interface element.

2. The electronic device defined in claim 1, wherein shifting the user interface element towards the selection region comprises shifting the user interface element towards the selection region while it is determined that the gaze input targets the user interface element.

3. The electronic device defined in claim 1, wherein performing the action associated with the user interface element is further in accordance with a determination that the gaze input targets the user interface element for more than a threshold length of time while the user interface element is located at the selection region.

4. The electronic device defined in claim 1, wherein performing the action associated with the user interface element comprises increasing a size of the user interface element, displaying additional information, or adjusting an input-output device setting.

5. The electronic device defined in claim 1, wherein shifting the user interface element towards the selection region comprises shifting an additional user interface element away from the selection region.

6. The electronic device defined in claim 1, wherein the instructions further comprise instructions for:
obtaining, via a second subset of the one or more sensors, head pose information, wherein shifting the user interface element towards the selection region comprises:
based on the head pose information, shifting the user interface element towards the selection region at a variable rate while it is determined that the gaze input targets the user interface element.

7. The electronic device defined in claim 6, wherein shifting the user interface element towards the selection region comprises shifting the user interface element in a first direction and wherein shifting the user interface element towards the selection region at the variable rate while it is determined that the gaze input targets the user interface element comprises:
increasing the variable rate in response to the head pose information indicating a head movement in the first direction; and
decreasing the variable rate in response to the head pose information indicating a head movement in a second direction that is opposite the first direction.

8. The electronic device defined in claim 1, wherein the instructions further comprise instructions for displaying, via the one or more displays, a selection indicator at the selection region and wherein the selection indicator comprises a partial outline of the selection region, a complete outline of the selection region, or a highlighted area.

9. A method of operating an electronic device that comprises one or more sensors and one or more displays, the method comprising:
displaying, using the one or more displays, a user interface element;
obtaining, via a first subset of the one or more sensors, a gaze input;
in accordance with a determination that the gaze input targets the user interface element and the user interface element is not located at a selection region, shifting the user interface element towards the selection region; and
in accordance with a determination that the gaze input targets the user interface element and the user interface element is located at the selection region, performing an action associated with the user interface element.

10. The method defined in claim 9, wherein shifting the user interface element towards the selection region comprises shifting the user interface element towards the selection region while it is determined that the gaze input targets the user interface element.

11. The method defined in claim 9, wherein performing the action associated with the user interface element is further in accordance with a determination that the gaze input targets the user interface element for more than a threshold length of time while the user interface element is located at the selection region.

12. The method defined in claim 9, wherein performing the action associated with the user interface element comprises increasing a size of the user interface element, displaying additional information, or adjusting an input-output device setting.

13. The method defined in claim 9, wherein shifting the user interface element towards the selection region comprises shifting an additional user interface element away from the selection region.

14. The method defined in claim 9, further comprising:
obtaining, via a second subset of the one or more sensors, head pose information, wherein shifting the user interface element towards the selection region comprises:
based on the head pose information, shifting the user interface element towards the selection region at a variable rate while it is determined that the gaze input targets the user interface element.

15. The method defined in claim 14, wherein shifting the user interface element towards the selection region comprises shifting the user interface element in a first direction and wherein shifting the user interface element towards the selection region at the variable rate while it is determined that the gaze input targets the user interface element comprises:
increasing the variable rate in response to the head pose information indicating a head movement in the first direction; and
decreasing the variable rate in response to the head pose information indicating a head movement in a second direction that is opposite the first direction.

16. The method defined in claim 9, further comprising:
displaying, via the one or more displays, a selection indicator at the selection region, wherein the selection indicator comprises a partial outline of the selection region, a complete outline of the selection region, or a highlighted area.

17. A non-transitory computer-readable storage medium of operating an electronic device that comprises one or more sensors and one or more displays, the one or more programs including instructions for:
displaying, using the one or more displays, a user interface element;
obtaining, via a first subset of the one or more sensors, a gaze input;
in accordance with a determination that the gaze input targets the user interface element and the user interface element is not located at a selection region, shifting the user interface element towards the selection region; and
in accordance with a determination that the gaze input targets the user interface element and the user interface element is located at the selection region, performing an action associated with the user interface element.

18. The non-transitory computer-readable storage medium defined in claim 17, wherein shifting the user interface element towards the selection region comprises shifting the user interface element towards the selection region while it is determined that the gaze input targets the user interface element.

19. The non-transitory computer-readable storage medium defined in claim 17, wherein performing the action associated with the user interface element is further in accordance with a determination that the gaze input targets the user interface element for more than a threshold length of time while the user interface element is located at the selection region. The non-transitory computer-readable storage medium defined in claim 17, wherein performing the action associated with the user interface element comprises increasing a size of the user interface element, displaying additional information, or adjusting an input-output device setting.

21. The non-transitory computer-readable storage medium defined in claim 17, wherein shifting the user interface element towards the selection region comprises shifting an additional user interface element away from the selection region.

22. The non-transitory computer-readable storage medium defined in claim 17, wherein the instructions further comprise instructions for:
obtaining, via a second subset of the one or more sensors, head pose information, wherein shifting the user interface element towards the selection region comprises:
based on the head pose information, shifting the user interface element towards the selection region at a variable rate while it is determined that the gaze input targets the user interface element.

23. The non-transitory computer-readable storage medium defined in claim 22, wherein shifting the user interface element towards the selection region comprises shifting the user interface element in a first direction and wherein shifting the user interface element towards the selection region at the variable rate while it is determined that the gaze input targets the user interface element comprises:
increasing the variable rate in response to the head pose information indicating a head movement in the first direction; and
decreasing the variable rate in response to the head pose information indicating a head movement in a second direction that is opposite the first direction.

24. The non-transitory computer-readable storage medium defined in claim 17, wherein the instructions further comprise instructions for:
displaying, via the one or more displays, a selection indicator at the selection region, wherein the selection indicator comprises a partial outline of the selection region, a complete outline of the selection region, or a highlighted area.
